(19) United States
(12) Patent Application Publication
(10) Pub. No.: US 2026/0105140 A1
(43) Pub. Date: Apr. 16, 2026

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: KENTARO TAKAHASHI, Tokyo (JP)

(21) Appl. No.: 19/339,820

(22) Filed: Sep. 25, 2025

(30) Foreign Application Priority Data
Oct. 10, 2024 (JP) 2024-177598

(51) Int. Cl. G06F 21/44; G06K 15/00

(52) U.S. Cl. CPC G06F 21/44; G06K 15/005; G06K 15/408

(57) ABSTRACT

An information processing apparatus having an authenticating function using authentication information includes a recovery execution unit that resets authentication information in the information processing apparatus to a factory shipment state, where the recovery execution unit does not reset authentication information updated from the factory shipment state to authentication information in the factory shipment state.

### BACKGROUND

### Field of the Technology

The present disclosure relates to an information processing apparatus, a method of controlling the information processing apparatus, and a storage medium.

### DESCRIPTION OF THE RELATED ART

An administrative right to an information processing apparatus is provided by authentication of a user as an administrator. The authentication is generally performed by entry of authentication information composed of a user name and a password.

A default value of the authentication information is set as a factory shipment setting of the information processing apparatus, and is described in a manual and the like as known information in many cases.

Since the authentication information in such a default state is vulnerable in terms of security, it is recommended that the authentication information be reset.

In this regard, a method of storing an operation log after initialization until change of the authentication information and examining an invalid operation has been devised (Japanese Patent No. 7470572).

The method of execution of recovery to initialize the information processing apparatus to a factory shipment setting state in Japanese Patent No. 7470572 is seen to also initialize the reset authentication information. This can bring the authentication information into the vulnerable default state.

### SUMMARY

According to an aspect of the present disclosure, an information processing apparatus having an authenticating function using authentication information includes a recovery execution unit configured to reset authentication information in the information processing apparatus to a factory shipment state, wherein the recovery execution unit is further configured to not reset authentication information updated from the factory shipment state to authentication information in the factory shipment state.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an example of a hardware configuration of an information processing apparatus.

FIG. 2 is a schematic diagram illustrating a software configuration of the information processing apparatus.

FIGS. 3A and 3B are schematic diagrams each illustrating a functional configuration of the information processing apparatus.

FIG. 4 illustrates an example of a setting screen displayed by the information processing apparatus according to a first embodiment.

FIG. 5 illustrates an example of an authentication screen displayed by the information processing apparatus according to the first embodiment.

FIG. 6 illustrates an example of an initialization operation screen displayed by the information processing apparatus according to the first embodiment.

FIG. 7 illustrates an example of data held by the information processing apparatus according to the first embodiment.

FIG. 8 illustrates an example of authentication information held by the information processing apparatus according to the first embodiment.

FIG. 9 is a flowchart of authentication processing executed by the information processing apparatus according to the first embodiment.

FIG. 10 is a flowchart of initialization processing executed by the information processing apparatus according to the first embodiment.

FIG. 11 is a flowchart of initialization processing executed by the information processing apparatus according to a second embodiment.

FIG. 12 is a flowchart of initialization processing executed by the information processing apparatus according to a third embodiment.

FIG. 13 is a flowchart of initialization processing executed by the information processing apparatus according to a fourth embodiment.

FIG. 14 illustrates an example of a screen for the information processing apparatus to update the authentication information according to the first embodiment.

FIG. 15 is a schematic diagram illustrating an example of a hardware configuration of the information processing apparatus according to the third embodiment.

FIG. 16 is a schematic diagram illustrating a software configuration constructed on the information processing apparatus according to the third embodiment.

### DESCRIPTION OF THE EMBODIMENTS

Modes for implementing the present disclosure will be described with reference to the attached drawings.

### <First Embodiment>

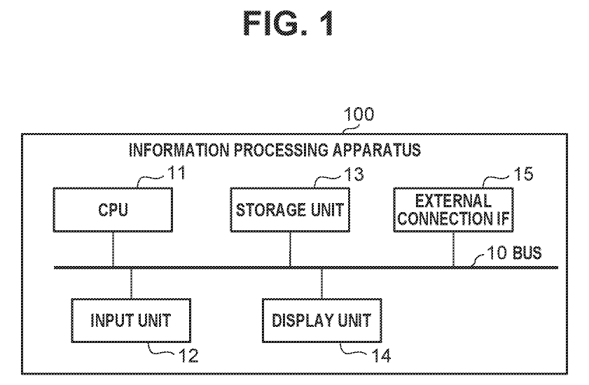

FIG. 1 is a diagram illustrating an example of a hardware configuration of a general information processing apparatus 100. As illustrated in FIG. 1, the information processing apparatus 100 includes a central processing unit (CPU) 11.

As illustrated in FIG. 1, the information processing apparatus 100 includes a central processing unit (CPU) 11. The CPU 11 performs processing based on a program stored in a storage unit 13 and corresponding to each of an application, a program execution environment, or the like, which will be described below, and thereby implements each function or a flowchart, which will be described below.

An input unit 12, the storage unit 13, a display unit 14, and an external connection interface (IF) 15 are connected to the CPU 11 via a bus 10. The input unit 12 is a keyboard and/or a mouse with which information is input. The storage unit 13 includes, for example, a read-only memory (ROM), a random-access memory (RAM), and a hard disk device, and stores, in addition to each program described above, data and the like to be used in processing based on each program. The display unit 14 is a display that displays a screen and the like. The external connection IF 15 serves as a network interface and various kinds of connection interfaces with external apparatuses.

The CPU 11 executes a program and can thereby function as various kinds of units. Additionally, a control circuit such as an application-specific integrated circuit (ASIC) that operates in coordination with the CPU 11 may function as these units. Alternatively, coordination between the CPU 11 and a control circuit that controls the operation of the information processing apparatus 100 may implement these units.

The CPU 11 is not necessarily a single unit, and may be composed of a plurality of units In this case, the plurality of CPUs 11 execute distributed processing. The plurality of CPUs 11 may be disposed in a single computer, or may be disposed in a plurality of physically different computers. The units implemented by execution of the program by the CPU 11 may be implemented by a dedicated circuit.

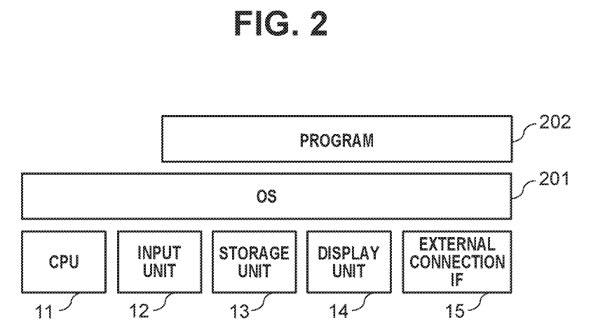

FIG. 2 is a diagram illustrating an example of a system configuration of the information processing apparatus 100. An operating system 201 (hereinafter referred to as the OS 201) is software that serves as a platform for the system. A program 202 is software that operates on the OS 201. The system configuration is similar to that of a general computer.

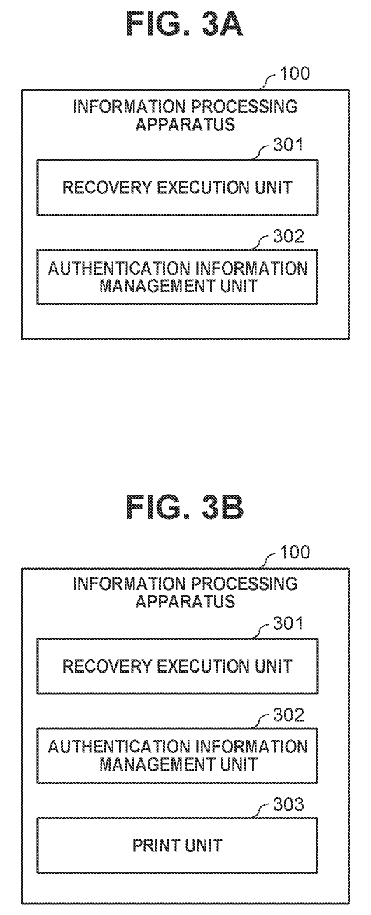

FIG. 3A illustrates a configuration of functions included in the information processing apparatus 100. The information processing apparatus 100 includes a recovery execution unit 301 that resets authentication information in the information processing apparatus 100 to an initial state that is equivalent to a factory shipment setting (factory shipment state). The information processing apparatus 100 is brought into the state equivalent to the factory shipment setting by clearing a database of the information processing apparatus 100.

The information processing apparatus 100 has an authentication function using the authentication information, and includes an authentication information management unit 302 that manages the authentication information. To enter the authentication information, for example, a character string of a user name and a password is used, but entry is not limited to this, and may be made with a four-digit number or by a gesture on a touch panel. The following description is provided assuming that the authentication information is the character string of a user name and password.

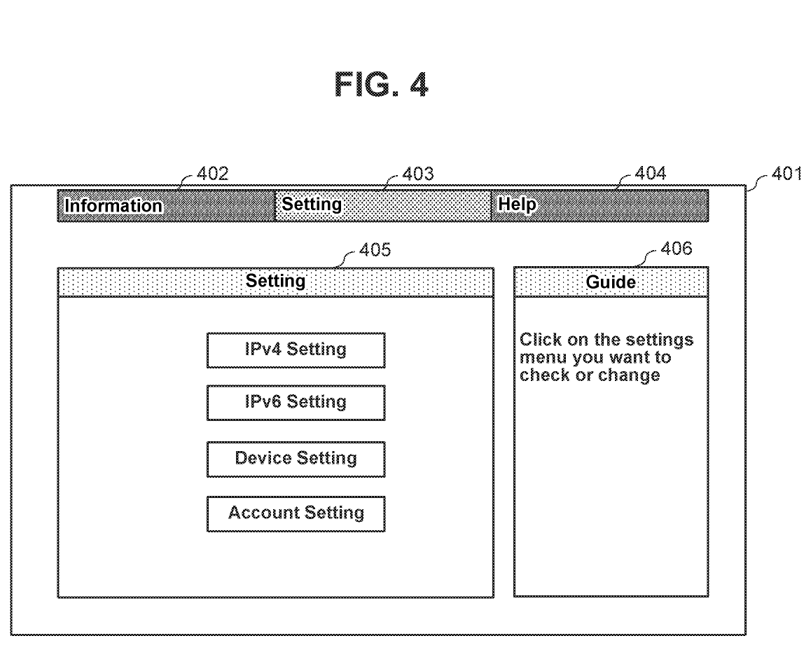

FIG. 4 illustrates an example of a screen displayed by the information processing apparatus 100. The screen may be displayed on a display screen included in the information processing apparatus 100 or may be displayed when the user accesses the information processing apparatus 100 from a personal computer (PC) or a smartphone using a web browser. A frame 401 in FIG. 4 is a frame of the entire display screen. Menus 402, 403, and 404 in FIG. 4 are operation menus of the information processing apparatus 100. The example in FIG. 4 indicates a state where the menu 403 is selected, and details of the menu 403 are displayed in a region 405 in a lower part of the screen.

An instruction for an operation and a hint are displayed in a region 406. Because there is a risk for information leakage and issues if various types of settings of the information processing apparatus 100 can be made by anyone, authentication is required before an operation to implement any settings.

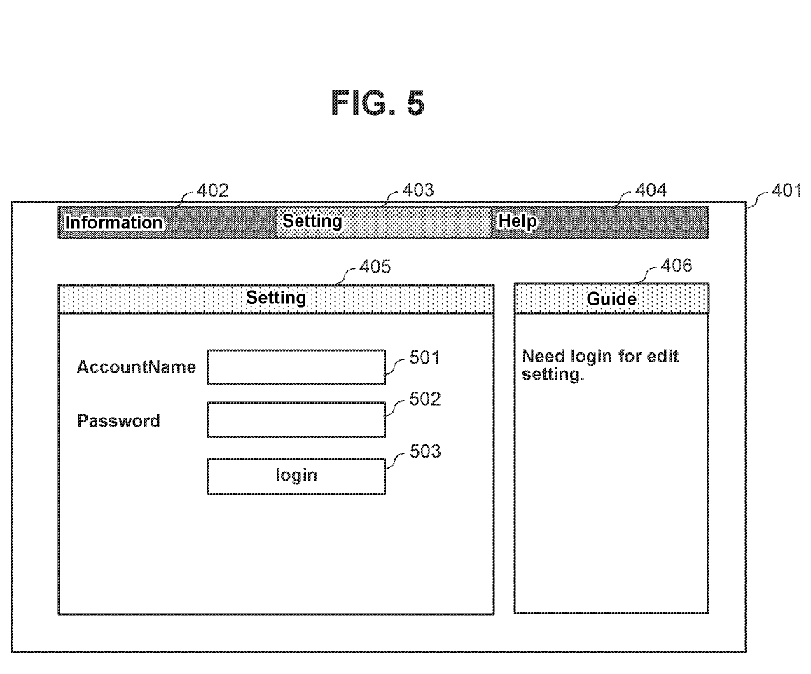

FIG. 5 illustrates an example of an authentication screen displayed by the information processing apparatus 100. This screen is displayed when the user selects the menu 403 or an item that requires authentication in the region 405. An entry field 501, an entry field 502, and a login button 503 are displayed in the region 405. The user name as the authentication information is entered in the entry field 501, the password is entered in the entry field 502, and authentication is executed by using the login button 503.

Default authentication information is generally set as a factory shipment setting of an information processing apparatus, and is described in a product manual and the like. The default authentication information is an initial setting, and applied as the factory shipment setting or at the time of reset of authentication information in the information apparatus.

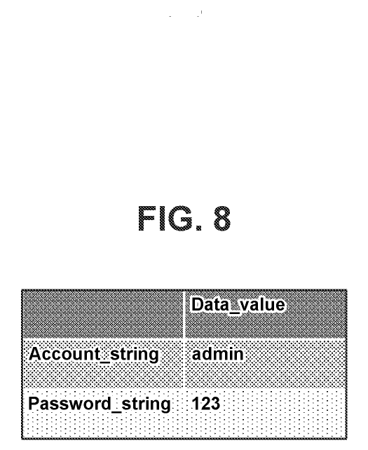

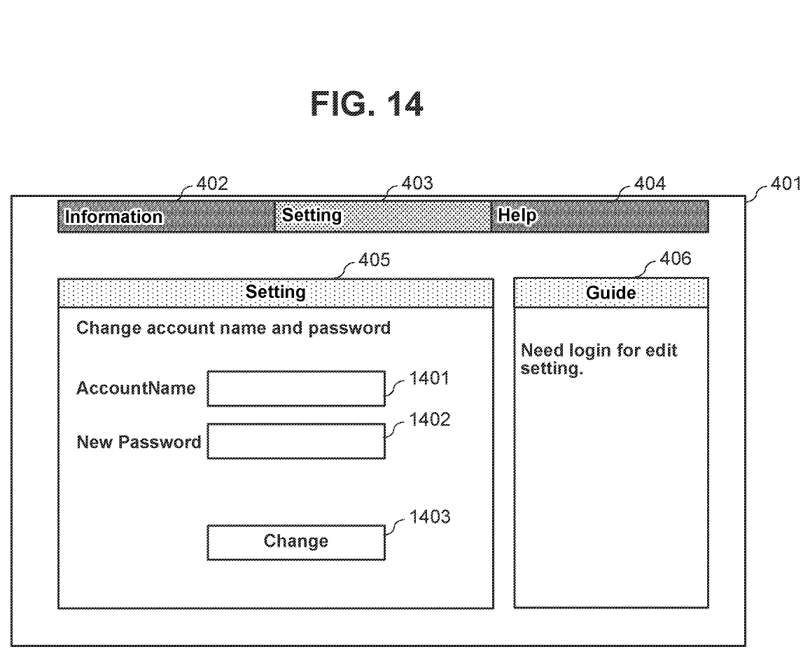

Since the default authentication information poses a security risk, the user can change the authentication information. The screen to change the authentication information is typically a screen as illustrated in FIG. 14. In FIG. 14, a new user name is entered in an entry field 1401, a new password is entered in an entry field 1402, and a button 1403 is pressed, whereby the change is executed. FIG. 8 illustrates an example of a database where the changed data is stored.

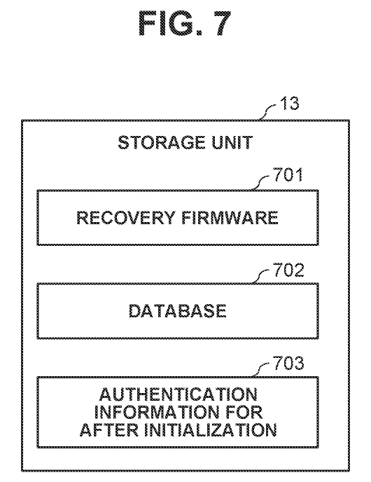

Details of data stored in the information processing apparatus 100 are described with reference to FIG. 7.

The OS 201 of the information processing apparatus 100 and recovery firmware 701 composed of an execution program of the program 202 and the like are stored in the storage unit 13. Loading the recovery firmware 701 in a region read at the time of startup of the information processing apparatus 100 enables the OS 201 of the information processing apparatus 100 and the program 202 to be initialized. The recovery firmware 701 is typically stored in a read-only region of the storage unit 13, but this is not seen to be limiting..

The database 702 is stored in a read/write region of the storage unit 13. Data associated with the above-described authentication information with reference to FIG. 8, a network setting, and the like are stored in the database 702. Authentication information for after initialization 703 performed in the present embodiment is also stored in the database 702. The authentication information for after initialization 703 may be in a text file or in a database that is independent of the database 702.

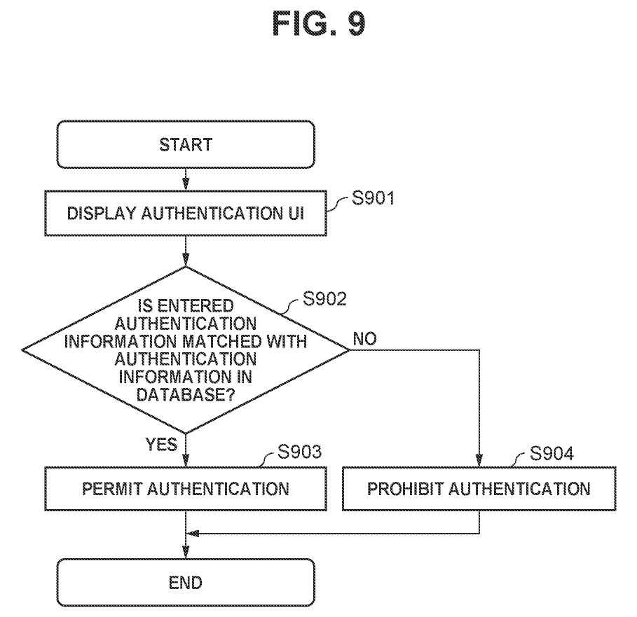

The flow of authentication processing executed by the information processing apparatus 100 is described with reference to FIG. 9. The processing in the flowchart in FIG. 9 starts when the user performs an operation that requires the authentication information.

First, in step S901, the information processing apparatus 100 displays the authentication screen illustrated in FIG. 5. In step S902, the information processing apparatus 100 determines whether the authentication information entered via the authentication screen matches the authentication information stored in the database 702.

As a checking method, it is easy for the information processing apparatus 100 to collate the authentication information in the database illustrated in FIG. 8 and the entered authentication information with each other. In a case where the entered authentication information is matches the stored authentication information in the database (YES in step S902), the processing proceeds to step S903. In step S903, the information processing apparatus 100 permits the authentication. In a case where the entered authentication information does not match the stored authentication information in the database (NO in step S902), the processing proceeds to step S904. In step S904, the information processing apparatus 100 prohibits the authentication. The processing then ends.

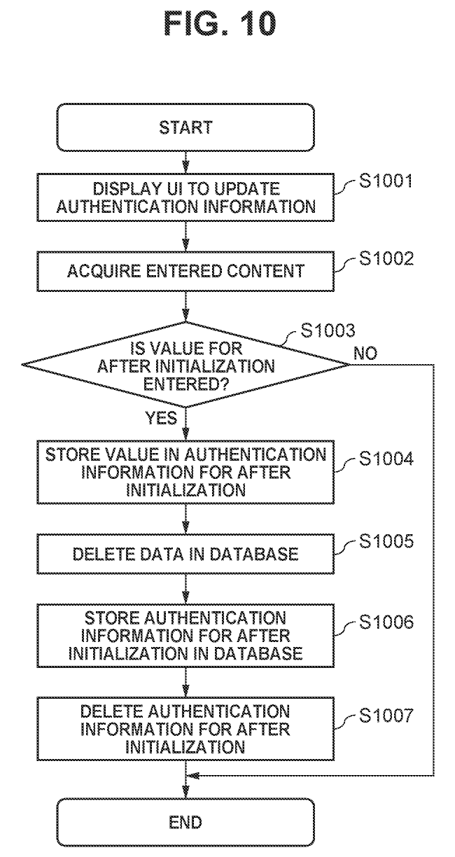

The flow of processing executed by the information processing apparatus 100 to execute initialization is described with reference to FIG. 10. The processing in the flowchart in FIG. 10 starts when the user performs an operation of instructing initialization.

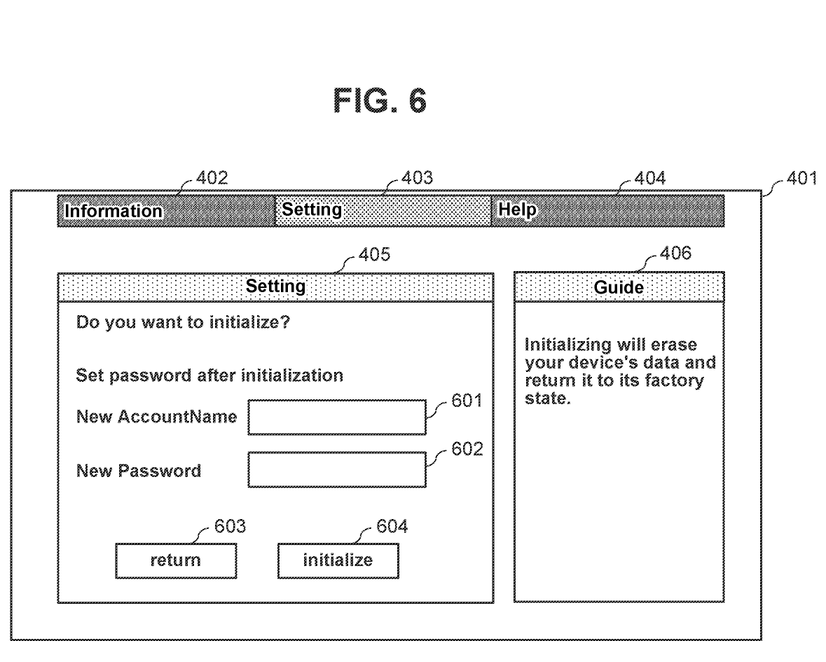

First, in step S1001, the information processing apparatus 100 displays the screen to update the authentication information in FIG. 6.

FIG. 6 illustrates an example of a screen displayed when the user instructs execution of initialization of the information processing apparatus 100. Regions 601 and 602 are displayed on this screen, where new authentication information to be applied after the initialization is entered in the regions 601 and 602. A button 604 and a button 603 are displayed on the screen. The button 604 is used for the user to instruct the start of execution of the initialization, while the button 603 is used for the user to return to an operation without execution of the initialization.

Returning to FIG. 10, in step S1002, the information processing apparatus 100 acquires contents entered on the screen illustrated in FIG. 6. In step S1003, the information processing apparatus 100 determines whether respective values are entered in the regions 601 and 602. In a case where no value is entered in either region 601 or region 602 (NO in step S1003), the information processing apparatus 100 ends the processing without executing the initialization.

In a case where the respective values are entered in the regions 601 and 602 (YES in step S1003), the processing proceeds to step S1004. In step S1004, the information processing apparatus 100 stores these values in authentication information for after initialization 703.

In step S1005, the information processing apparatus 100 deletes data in the database 70 by clearing all tables in the database 702. By deleting various types of settings and histories that are related to the information processing apparatus 100 and that are stored in the database 702, the information processing apparatus 100 is returned to a state that is equivalent to the factory shipment setting. In step S1006, the information processing apparatus 100 stores the authentication information for after initialization 703 stored in step S1004 in the database 702. The authentication information, based on the processing in step S1006, collated by the information processing apparatus 100 in step S902 becomes the authentication information entered on the screen in FIG. 6.

In step S1007, the information processing apparatus 100 deletes the authentication information for after initialization 703 stored in step S1004. If necessary, the information processing apparatus 100 may perform processing of applying the recovery firmware 701 to itself in any of steps S1005, S1006, and S1007.

The above-described description discusses the processing executed by the information processing apparatus 100 to accept registration of the authentication information before execution of recovery and automatically reset the authentication information after the recovery.

### <Second Embodiment>

Turning back to the operation screen for initializing the information processing apparatus 100 illustrated in FIG. 6, the regions 601 and 602 that are used to enter the authentication information to be applied after initialization are displayed blank in the first embodiment. This makes it easy to enter new authentication information.

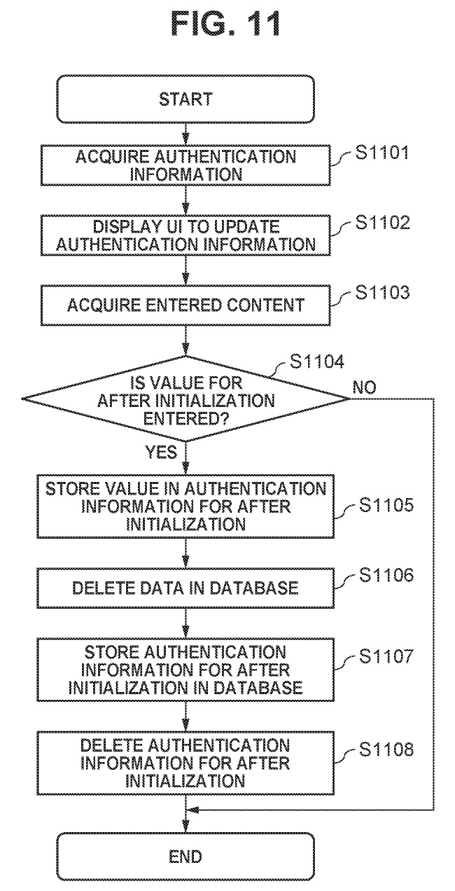

There are many cases where the user wants to initialize the information processing apparatus 100 and only wants to share a current setting regarding the authentication information. In these situations, a method of easily performing an operation to share only the authentication information will be described as a second embodiment. The processing in the flowchart in FIG. 11 starts when the user performs an operation of instructing initialization.

FIG. 11 is a flowchart illustrating initialization processing executed by the image processing apparatus 100 according to the second embodiment. The processing in the flowchart in FIG. 11 starts when the user performs an operation of instructing initialization First, in step S1101, the information processing apparatus 100 acquires the set authentication information, from for example, the database in FIG. 8. In step S1102, the information processing apparatus 100 displays the screen to update the authentication information in FIG. 6. The screen is displayed in a state where the authentication information acquired in step S1101 has been entered in the regions 601 and 602 provided for entry of the authentication information.

In step S1103, the information processing apparatus 100 acquires the contents entered on the screen in FIG. 6. In step S1104, the information processing apparatus 100 determines whether respective values are entered in the regions 601 and 602. In a case where the respective values are entered in the regions 601 and 602 (YES in step S1104), the processing proceeds to step S1105. In step S1105, the information processing apparatus 100 stores these values in the authentication information for after initialization 703

In step S1106, the information processing apparatus 100 deletes data in the database 702. In step S1107, the information processing apparatus 100 stores the authentication information for after initialization 703 stored in step S1105 in the database 702. In step S1108, the information processing apparatus 100 deletes the authentication information for after initialization 703 stored in step S1105. The processing then ends.

The above-described method enables performing the operation to easily share only the authentication information in the processing of initializing the information processing apparatus 100.

### <Third Embodiment>

The first embodiment provided a description of a method for the user to set authentication information that is different from existing authentication information. Many users forget the authentication information that is different from the existing authentication information. Examples of an information processing apparatus that requires authentication for an operation include an information processing apparatus with a function of printing confidential business documents. In this configuration, in a case where the authentication information that is different from the existing authentication information is set, printing the authentication information and causing the user to store the authentication information makes it possible to prevent issues when the user forgets the authentication information.

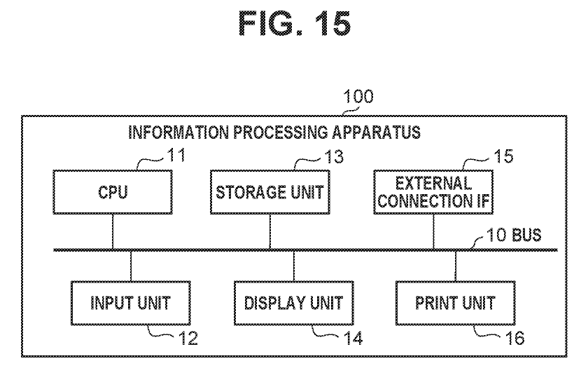

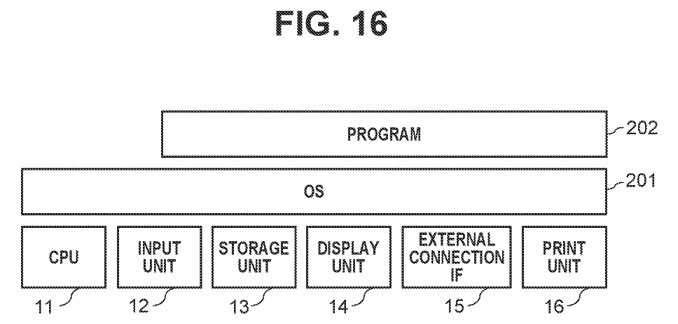

A third embodiment provides a method of printing the authentication information and causing the user to store the authentication information. FIG. 15 is a diagram illustrating an example of a hardware configuration of the information processing apparatus 100 according to the third embodiment. The information processing apparatus 100 of the present embodiment includes all the elements of the image processing apparatus 100 illustrated in FIG. 1 in addition to a print unit 16 that executes printing. The system configuration of the information processing apparatus 100 of the present embodiment illustrated in FIG. 16 includes all of the elements of the image processing apparatus 100 illustrated in FIG. 2. and includes the print unit 16. Thus, the OS 201 is configured to also control the print unit 16. FIG. 3B illustrates a configuration of functions included in the information processing apparatus 100 according to the present embodiment and includes all of the elements illustrated in FIG. 3A and a print unit 303 that executes printing.

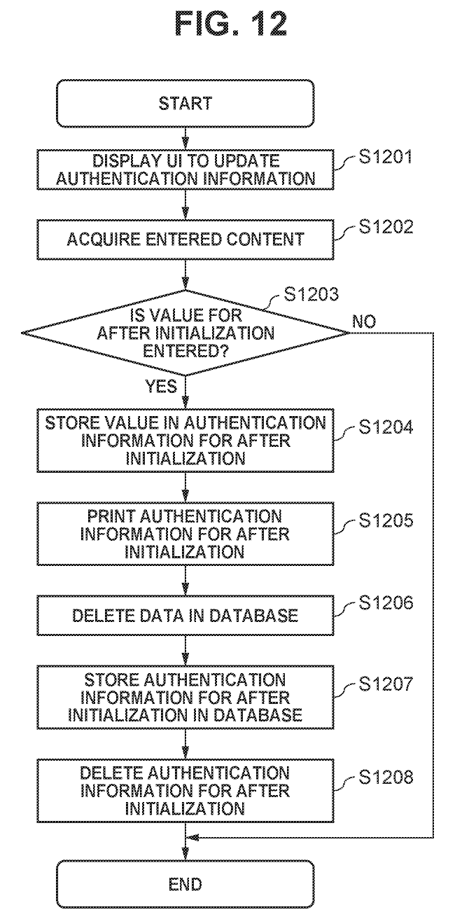

The flow of processing of initializing the information processing apparatus 100 according to the third embodiment is described with reference to FIG. 12. The processing in the flowchart in FIG. 12 starts when the user performs an operation of instructing initialization.

First, in step S1201, the information processing apparatus 100 displays the screen to update the authentication information in FIG. 6. In step S1202, the information processing apparatus 100 acquires contents entered on the screen illustrated in FIG. 6. In step S1203, the information processing apparatus 100 determines whether respective values are entered in the regions 601 and 602. In a case where the respective values are entered in the regions 601 and 602 (YES in step S1203), the processing proceeds to step S1204. In step S1204, the information processing apparatus 100 stores these values in authentication information for after initialization 703.

In step S1205, the information processing apparatus 100 prints and outputs these vales with the print unit 303. In step S1206, the information processing apparatus 100 deletes data in the database 702. In step S1207, the information processing apparatus 100 stores the authentication information for after initialization 703 stored in step S1204 in the database 702.

In step S1208, the information processing apparatus 100 deletes the authentication information for after initialization 703 stored in step S1204. The processing then ends.

The above description provides a method of printing the authentication information and causing the user to store the authentication information in the processing of initializing the information processing apparatus 100.

### <Fourth Embodiment>

In the first embodiment, in a case where the authentication information for after initialization is not entered in step S1003, the information processing apparatus 100 ends the processing without executing the initialization. It is possible to reduce operational burdens on the user more significantly by applying the default authentication information and executing the initialization in a case where the authentication information for after initialization is not entered.

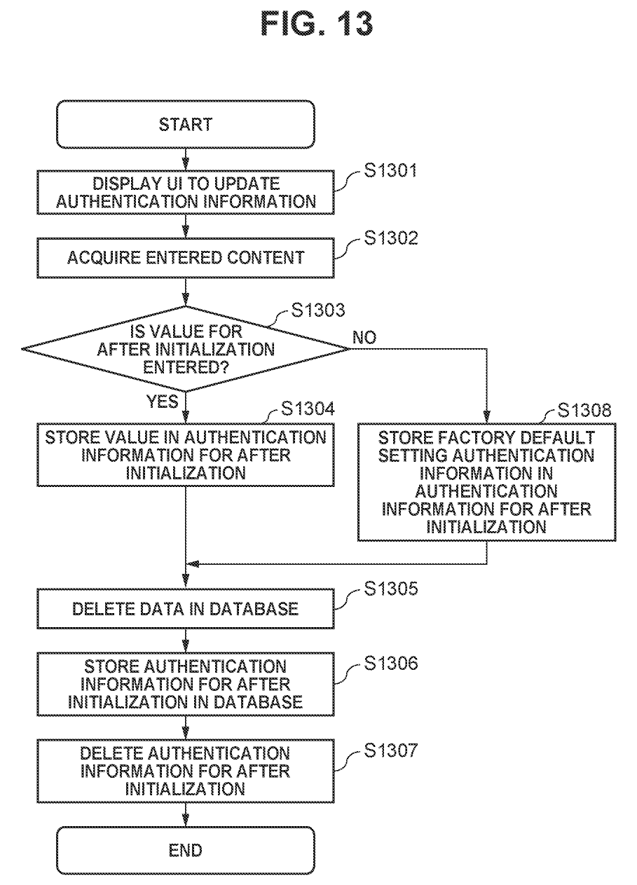

A fourth embodiment directed to a method of applying the default authentication information and executing the initialization in a case where the authentication information for after initialization is not entered will be described with reference to FIG. 13.

The processing in the flowchart in FIG. 13 starts when the user performs an operation of instructing initialization. First, in step S1301, the information processing apparatus 100 displays the screen to update the authentication information in FIG. 6.

In step S1302, the information processing apparatus 100 acquires the contents entered on the screen in FIG. 6. In step S1303, the information processing apparatus 100 determines whether respective values are entered in the regions 601 and 602. In a case where the respective values are entered in the regions 601 and 602 (YES in step S1303), the processing proceeds to step S1304. In step S1304, the information processing apparatus 100 stores these values in authentication information for after initialization 703.

In step S1305, the information processing apparatus 100 deletes data in the database 702. In step S1306, the information processing apparatus 100 stores the authentication information for after initialization 703 stored in step S1104 in the database 702. In step S1307, the information processing apparatus 100 deletes the authentication information for after initialization 703 stored in step S1304.

In a case where the respective values are not entered in the regions 601 and 602 (NO in step S1303), the processing proceeds to step S1308. In step S1308, the information processing apparatus 100 stores default authentication information as the factory shipment setting in the authentication information for after initialization 703. The default authentication information as the factory shipment setting is easily acquired from the recovery firmware 701 or the like. The processing then ends.

The above description provides the method of applying the default authentication information and executing the initialization in a case where the authentication information for after initialization is not entered in the processing of initializing the information processing apparatus 100.

### <Other Embodiments>

The information processing apparatus 100 may be configured to select, in a case of execution of initialization, whether to bring the authentication information changed from the factory shipment state into a factory initialized state. A selection button may be prepared in a display or the like of the information processing apparatus 100 to enable the selection.

In a case where it is selected to initialize the authentication information, the authentication information in the factory shipment state is set. In a case where it is selected not to initialize the authentication information, the authentication information updated from the factory shipment state is set as the authentication information.

In an embodiment where an information processing apparatus does not include the print unit 303, another method of preventing the issue of forgetting the authentication information comprises transmitting the authentication information to an e-mail address registered as an e-mail address of an administrator (a method of notifying the user). The authentication information is transmitted to an external apparatus via a communication unit using an email and notified to the user. In another embodiment, the authentication information may be displayed on a display unit of an external apparatus (for example, a terminal apparatus such as a PC or a smartphone) similarly via the communication unit.

While details of various embodiments have been described, the present disclosure includes embodiments as a system, an apparatus, a control method, a control program, and a recording medium (storage medium).

The present disclosure may be applied to a system composed of a plurality of devices (for example, a host computer, an interface device, an imaging apparatus, and a web application) or an apparatus composed of one device.

The present disclosure can be achieved by a recording medium (or a computer-readable storage medium) that records control program codes (computer program) of software that implements functions of the above-mentioned embodiments installed in a system or an apparatus. The storage medium.

The system or a computer of the apparatus (or a CPU or a microprocessing unit (MPU)) reads out the control program codes stored in the recording medium and executes the control program codes. The control program codes themselves, which are read out from the recording medium, implement the above-mentioned functions according to the embodiments, and the recording medium that stores the control program codes constitutes the present disclosure.

According to the present disclosure, reset authentication information is not initialized even if recovery is executed to initialize the information processing apparatus to the factory shipment state, and it is possible to avoid the authentication information from becoming the default authentication information that is vulnerable in terms of security.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-177598, filed October 10, 2024, which is hereby incorporated by reference herein in its entirety.

What is claimed is:

1. An information processing apparatus having an authenticating function using authentication information, the information processing apparatus comprising:
a recovery execution unit configured to reset authentication information in the information processing apparatus to a factory shipment state,
wherein the recovery execution unit is further configured to not reset authentication information updated from the factory shipment state to authentication information in the factory shipment state.

2. The information processing apparatus according to claim 1, further comprising a notification unit configured to, in a case where the recovery execution unit executes recovery, notify a user of the authentication information updated from the factory shipment state.

3. The information processing apparatus according to claim 2, wherein the notification unit is a display unit configured to display the authentication information, a print unit configured to print the authentication information, or a communication unit configured to notify an external apparatus of the authentication information.

4. The information processing apparatus according to claim 3, further comprising a selection unit configured to, in a case where recovery is executed, enable the user to select whether to reset the authentication information.

5. The information processing apparatus according to claim 4,
wherein, in a case where the user selects to reset the authentication information, the notification unit is a display unit configured to display the authentication information in the factory shipment state, a print unit configured to print the authentication information in the factory shipment state, or a communication unit configured to notify the external apparatus of the authentication information in the factory shipment state,
wherein, in a case where the user selects not to reset the authentication information, the notification unit is a display unit configured to display the authentication information updated from the factory shipment state, a print unit configured to print the authentication information updated from the factory shipment state, or a communication unit configured to notify the external apparatus of the authentication information updated from the factory shipment state.

6. A method of controlling an information processing apparatus having an authenticating function using authentication information, the method comprising:
executing recovery to reset authentication information in the information processing apparatus to a factory shipment state,
wherein executing recovery includes not resetting authentication information updated from the factory shipment state to authentication information in the factory shipment state.

7. A non-transitory computer-readable storage medium for storing a program causing an information processing apparatus having an authenticating function using authentication information to perform an information processing method, the method comprising:
executing recovery to reset authentication information in the information processing apparatus to a factory shipment state,
wherein executing recovery includes not resetting authentication information updated from the factory shipment state to authentication information in the factory shipment state.
